(19) United States
(12) Patent Application Publication
(10) Pub. No.: US 2008/0297404 A1
(43) Pub. Date: Dec. 4, 2008

(54) COMMUNICATION DEVICE WITH FRONT-END RADIO FREQUENCY ANTENNA MODULE

(76) Inventors: Tsung-Lang Lin, Taipei (TW); Hsiao Chi Yu, Taipei (TW)

Correspondence Address: G. LINK CO., LTD., 3550 BELL ROAD, MINOOKA, IL, 60447, US

(21) Appl. No.: 11/768,927

(22) Filed: Jun. 27, 2007

(30) Foreign Application Priority Data
Jun. 1, 2007 (TW) 096119713

(51) Int. Cl. H04B 1/00

(52) U.S. Cl. 342/195

(57) ABSTRACT

A radio frequency communication front-end device having a front-end radio frequency antenna module comprises a microchip antenna and a radio frequency front-end signal processing core chip, wherein the microchip antenna is used to emit and receive electromagnetic waves for signal communication with other wireless equipment. The present invention, as being in the form of a module, processes the radio frequency signals by means of the radio frequency front-end signal processing core chip and, therefore, achieves optimized efficiency of electromagnetic wave emission and reception.

### FIELD OF THE INVENTION

The present invention relates to a communication device having a front-end radio frequency (RF) antenna module and, particularly, to a communication device being capable of reducing the effect of the electromagnetic (EM) waves, which is emitted from the front-end RF antenna module of the communication device, on the communication device and other electric circuit.

### BACKGROUND OF THE INVENTION

Conventional wireless communication devices usually have undesirable transmission efficiency due to the intrinsic characteristic of antennas, thus resulting in a loss of signal. Increased emission power, or increased intensity of the EM waves, is often required for effective emission of RF signals so that the signals can be transformed into effective RF wireless signals for transmission. Moreover, with high frequency signals, those EM waves may cause RF coupling interference with other electric circuits in communication devices and, as a result, the degree of the difficulty in the circuit design for communication devices may be uplifted.

Refer to FIG. 1, which is an element relation diagram of an embodiment of a conventional mobile phone module, the module comprising a power amplifier 11, a low-pass filter 12, an RF switch 13, an antenna 14, a low-noise amplifier 15, a band-pass filter 16, an analog-to-digital (A/D) audio converter 21 connected to an audio input unit such as an input unit 3, a digital-to-analog (D/A) audio converter 22 with an audio output unit such as an output unit 4, and a micro control unit 5.

The A/D audio converter 21 has one end electrically connected to the input unit 3 and the other one end connected to the power amplifier 11. The power amplifier 11 may amplify the signals coming from the A/D audio converter 21 and then send the amplified signals to the low-pass filter 12 through an electric connection. The low-pass filter 12 may filter the signals and then send the signals to the RF switch 13 through an electric connection. The RF switch 13 is connected to the antenna 14. Therefore, the signals having been processed by the RF switch 13 may be sent to the antenna 14 from which the signals may be transformed into wireless EM waves to be emitted to perform signal communication with other wireless equipment; the EM waves being from outside and gathered by the antenna 14 may be transformed into signals to be processed by the RF switch 13. The RF switch 13 is electrically connected to the low-noise amplifier 15. The low-noise amplifier 15 may amplify the signals coming from the RF switch 13 and then send the amplified signals to the band-pass filter 16 through an electric connection. The band-pass filter 16 may purify the signals, filtering out redundant noise, and then send the signals to the D/A audio converter 22 through an electric connection. The signals, as being digital, may be converted into analog signals by the D/A audio converter 22. Then, the converted signals (being analog) may be output by the output unit 4, which is connected to the D/A audio converter 22. The micro control unit 5 is electrically connected to the RF switch 13, the A/D audio converter 21 and the D/A audio converter 22, individually, so that the RF switch 13, the A/D audio converter 21 and the D/A audio converter 22 may be controlled by the micro control unit 5 for achieving functions of signal converting and transmitting.

In view of the shortcoming of conventional communication devices, the inventor endeavored to invent a communication device having a front-end RF antenna module.

### SUMMARY OF THE INVENTION

An objective of the invention is to provide a communication device having a front-end RF antenna module, the communication device integrating a microchip antenna and an RF front-end signal processing core chip module so as to achieve optimal efficiency of EM wave emission and reception.

To realize the above-mentioned objectives, the invention provides a communication device having a front-end RF antenna module. The communication device comprises a microchip antenna and an RF front-end signal processing core chip module, wherein the front-end RF antenna module is used to emit and receive electromagnetic waves, for signal communication with other wireless equipment. The present invention, as being in the form of a module, achieves optimal efficiency of EM wave emission and reception.

A detailed description is given in the following embodiments with reference to the accompanying drawings, in order that those skilled in the art may appreciate the objective, characteristic and function of the present invention.

### BRIEF DESCRIPTION OF THE DRAWINGS

FIG. 1 is an element relation diagram of a conventional mobile phone module;

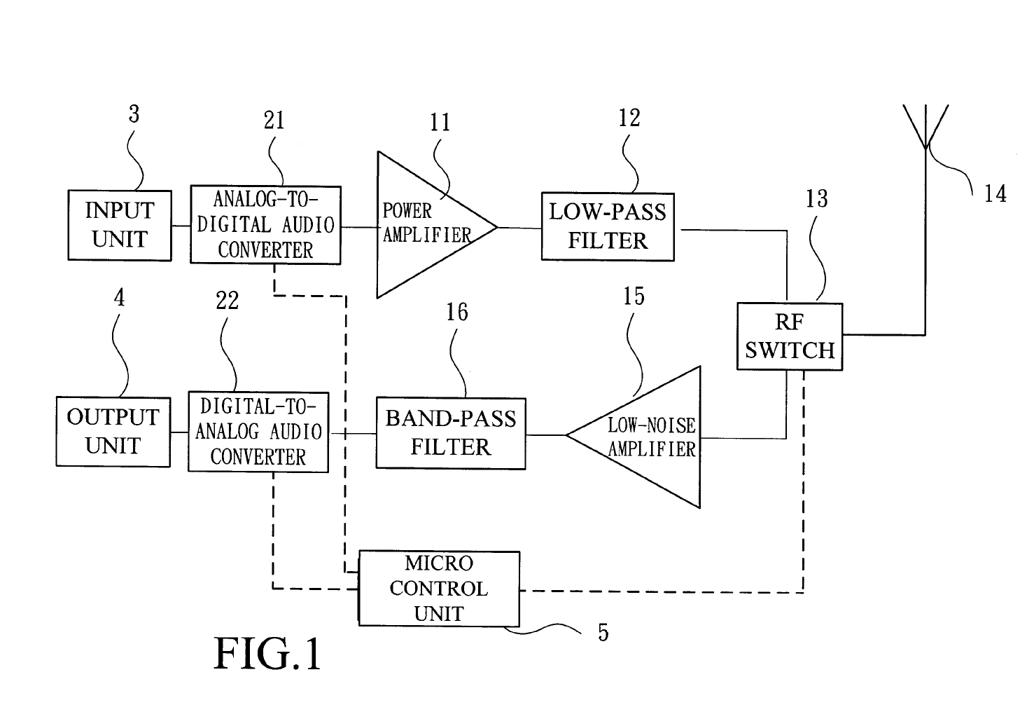

FIG. 2 is an element relation diagram of an embodiment of the communication device having a front-end RF antenna module according to the present invention; and

FIG. 3 is a schematic structure diagram of another embodiment of the communication device having a front-end RF antenna module according to the present invention.

### DETAILED DESCRIPTION OF THE INVENTION

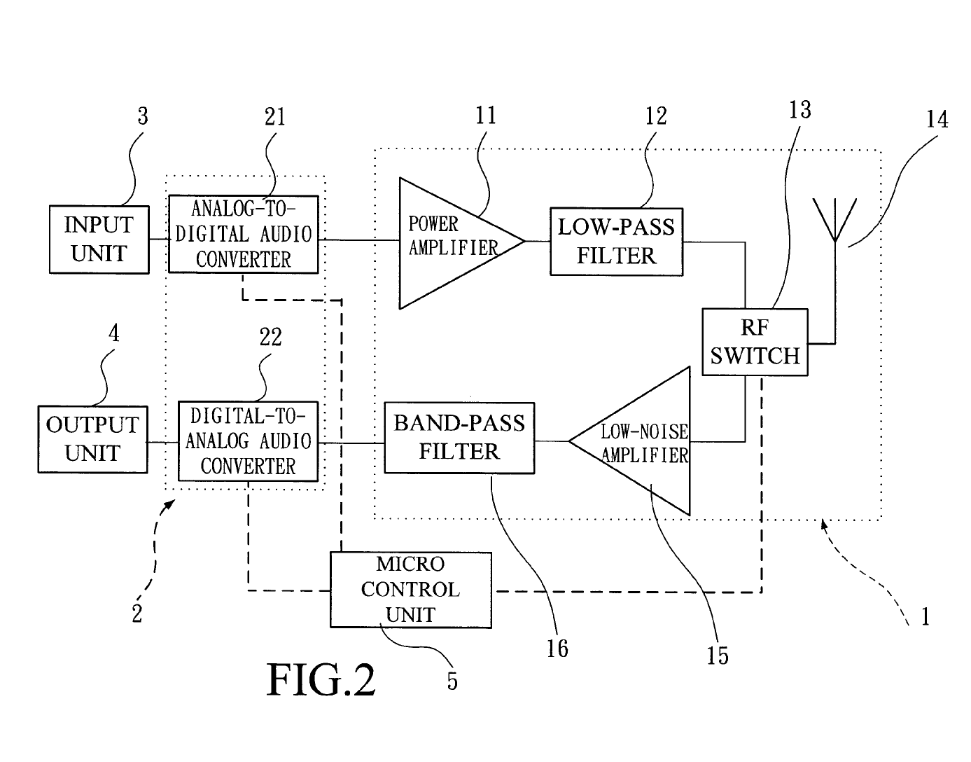

Refer to FIG. 2, which is an clement relation diagram of an embodiment of the communication device having a front-end RF antenna module according to the present invention. The communication device having the front-end RF antenna module according to the present invention comprises a front-end RF antenna module 1, a signal processing module 2, an input unit 3, an output unit 4 and a micro control unit 5, wherein the front-end RF antenna module 1 is used for wireless signal transmitting and signal processing; the signal processing module 2 is used for A/D signal converting; the input unit 3 is an audio input device such as a microphone, for inputting of audio signals; the output unit 4 is an audio output device such as a telephone receiver, for outputting of audio signals; and the micro control unit 5 is used for controlling the front-end RF antenna module 1 and the signal processing module 2 and further includes means for selection for controlling the signal transmitting and switching between the front-end RF antenna module 1 and the signal processing module 2. The signal processing module 2 is electrically connected to the input unit 3, the output unit 4 and the front-end RF antenna module 1; the output unit 4 is electrically connected to the front-end RF antenna module 1 and the signal processing module 2. Thus, the front-end RF antenna module 1 as receiving signals carrying voice information can transmit such signals to the signal processing module 2; audio information corresponding to such signals can be output by the output unit 4 under the control of the micro control unit 5. On the other hand, the input unit 3 as receiving voice information can transform such information into electric signals and transmit such signals to the front-end RF antenna module 1; RF signals corresponding to such audio information can be output by the front-end RF antenna module 1 under the control of the micro control unit 5.

In the above-mentioned embodiment of the communication device having a front-end RF antenna module according to the present invention, the front-end RF antenna module 1 further comprises a power amplifier 11, a low-pass filter 12, an RF switch 13, an antenna 14, a low-noise amplifier 15 and a band-pass filter 16, wherein the antenna 14 is embedded in the front-end RF antenna module 1 so that the optimal efficiency of EM wave emission and reception is achieved. In addition, the signal processing module 2 further comprises an A/D audio converter 21 and a D/A audio converter 22.

The A/D audio converter 21 has one end electrically connected to the input unit 3 and the other one end connected to the power amplifier 11. The power amplifier 11 can amplify the signals coming from the A/D audio converter 21 and then send the amplified signals to the low-pass filter 12 through an electric connection. The low-pass filter 12 can filter the signals and then send the signals to the RF switch 13 through an electric connection. The RF switch 13 is connected to the antenna 14. Therefore, the signals having been processed by the RF switch 13 are sent to the antenna 14 form which the signals are transformed into wireless EM waves to be emitted to perform signal communication with other wireless equipment; the EM waves coming from outside and gathered by the antenna 14 are transformed into signals to be processed by the RF switch 13. The RF switch 13 is electrically connected to the low-noise amplifier 15. The low-noise amplifier 15 can amplify the signals coming from the RF switch 13 and then send the amplified signals to the band-pass filter 16 through an electric connection. The band-pass filter 16 can purify the signals, filtering out redundant noise, and then send the signals to the D/A audio converter 22 through an electric connection. The signals, as being digital, are converted into analog signals by the D/A audio converter 22. Then, the converted signals (being analog) are output by the output unit 4, which is connected to the D/A audio converter 22. The micro control unit 5 is electrically connected to the RF switch 13, the A/D audio converter 21 and the D/A audio converter 22, individually, so that the RF switch 13, the A/D audio converter 21 and the D/A audio converter 22 cab be controlled by the micro control unit 5 for achieving functions of signal converting and transmitting.

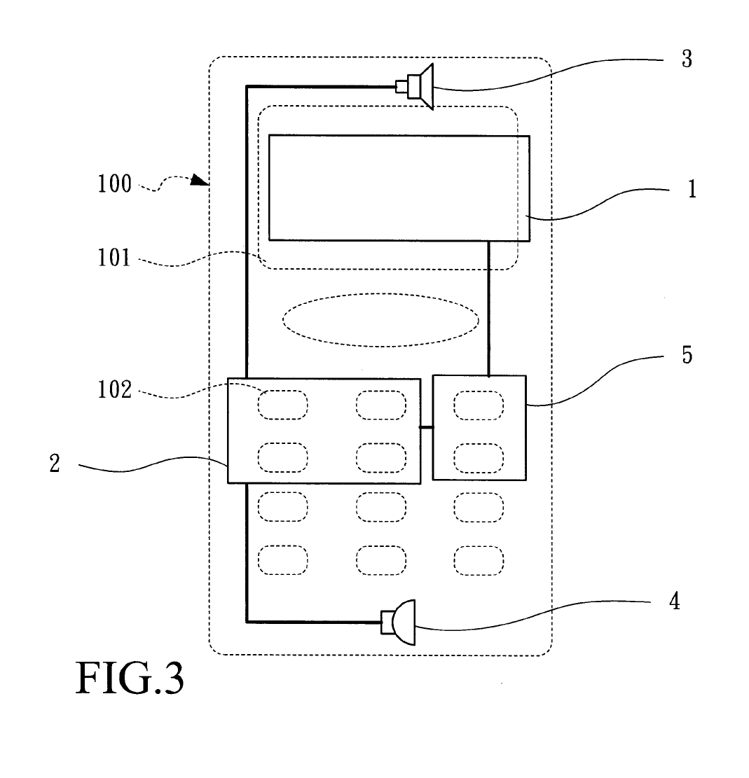

Refer to FIG. 3, which is a schematic structure diagram of an embodiment of the communication device having a front-end RF antenna module according to the present invention. This embodiment is illustrated by using a mobile phone 100. The mobile phone 100 has a screen 101 disposed on the surface thereof and has an input region 102, wherein the screen 101 is used for providing image output, and the input region 102 is used for providing lettered or symbolic information input. Yet, inside the mobile phone 100, said front-end RF antenna module 1, said signal processing module 2, said input unit 3, said output unit 4 and said micro control unit 5 are disposed, wherein the front-end RF antenna module 1 is disposed inside the mobile phone 100 in a position corresponding to the screen 101, and the input unit 3, the output unit 4 and the micro control unit 5 are disposed inside the mobile phone 100 in a position corresponding to the input region 102. Thus, the power amplifier 11, the low-pass filter 12, the RF switch 13, the antenna 14, the low-noise amplifier 15 and the band-pass filter 16 of the front-end RF antenna module 1 are far away from the input unit 3, the output unit 4 and the micro control unit 5 so that, during the operation of those elements of the front-end RF antenna module 1, high-frequency signals can be isolated from the electric circuit to further reduce the interference between electric signals.

Although the invention has been described by way of preferred embodiments, it is to be understood that the scope of the invention is not limited thereto. As would be apparent to those skilled in the art, any equivalent changes or modifications according to the spirit and scope of the claims appended will be encompassed by the invention.

What is claimed is:

1. A communication device with a front-end radio frequency antenna module, comprising:
a radio frequency antenna and a radio frequency front-end signal processing core chip module, wherein the front-end radio frequency antenna module is used for electromagnetic wave emitting and signal communication with other wireless equipment so that optimal efficiency of EM wave emission and reception can be achieved as the form of a module;
a signal processing module for processing the converting between analog signals and digital signals;
an input unit is an audio input device;
an output unit is an audio output device; and
a micro control unit for controlling the front-end RF antenna module and the signal processing module and further includes means for selection for controlling the signal transmitting and switching between the front-end RF antenna module and the signal processing module.

2. The communication device with a front-end radio frequency antenna module as claimed in claim 1, wherein the front-end radio frequency antenna module includes a circuit combining of power amplifiers and filters, an RF switch to transform the signals coming from the circuit into electromagnetic waves, and the antenna to emit the electromagnetic waves and receive electromagnetic waves coming from outside.

3. The communication device with a front-end radio frequency antenna module as claimed in claim 1, wherein the signal processing module can convert analog signals into digital signals and can convert digital signals into analog signals.

4. The communication device with a front-end radio frequency antenna module as claimed in claim 1, wherein the input unit is microphone or means for inputting number code signals.

5. The communication device with a front-end radio frequency antenna module as claimed in claim 1, wherein the output unit is a telephone receiver or a speaker.
